(19) United States
(12) Patent Application Publication
(10) Pub. No.: US 2022/0259368 A1
(43) Pub. Date: Aug. 18, 2022

(54) A POLYURETHANE COMPOSITION WITH REDUCED ALDEHYDE EMISSION

(71) Applicant: Huntsman Petrochemical LLC, The Woodlands, TX (US)

(72) Inventors: Renjie Ji, Shanghai (CN); Yide Liang, Shanghai (CN)

(21) Appl. No.: 17/627,393

(22) PCT Filed: Jul. 29, 2019
(86) PCT No.: PCT/US2019/043839

§ 371 Date: Jan. 14, 2022

(51) Int. Cl. C08G 18/48; C08G 18/18; C08G 18/38

(52) U.S. Cl. CPC C08G 18/4837; C08G 18/3848; C08G 18/18

(57) ABSTRACT

This disclosure generally provides compositions with reduced aldehyde emissions and more specifically provides polyurethane compositions useful in means of transport such as interior part of cars, wherein the polyurethane composition comprising: (a) a polyfunctional isocyanate; (b) an isocyanate reactive composition; (c) a compound of the formula (I), (d) a primary amine containing compound; and (e) a catalyst.

### FIELD OF THE INVENTION

This invention relates generally to polyurethane compositions with reduced aldehyde emissions and more specially to polyurethane compositions useful in means of transport such as interior part of cars.

### BACKGROUND INFORMATION

Emission of formaldehyde and acetaldehyde can cause unpleasant odours and health related problems. Methods of reducing formaldehyde emissions in polyurethane or polyurea (PU) compositions by using scavenger additives are already known in the art.

US20160304686 discloses the use of acidic compounds as aldehyde scavengers in polyurethanes. But these compounds work only for reducing formaldehyde emission.

WO2014026802 discloses the use of aldehyde scavengers (amine compounds) to reduce aldehyde emission in PU foam. But these compounds do not work well for reducing acetaldehyde emission.

US20060141236 discloses the use of hydrazine compounds as aldehyde scavengers in polyurethanes. But the viscosity of these compositions is very high.

US 20130203880 discloses the use of polyhydrazodicarbonamide to reduce aldehyde emissions in polyurethane foams. However, it only works when huge amount of polyhydrazodicarbonamide is added, which would influence the mechanic properties of the PU foam.

JP2005154599 discloses some additives that can be used as aldehyde scavengers. But such additives are not suitable for PU foam process.

However, known solutions are not able to provide a PU foam compositions which can significantly reduce both of the formaldehyde and the acetaldehyde emission.

### SUMMARY OF THE INVENTION

It has now been surprisingly found that the compositions and processes of the present disclosure address the above problem. Advantages of the present disclosure may include: (1) reduced aldehyde emission, especially formaldehyde and acetaldehyde emission; (2) low cost; and (3) no obvious influence on the mechanic properties of the foam.

The present disclosure is concerned with compositions with reduced aldehyde emission and processes for preparing these compositions. In one embodiment, the disclosure provides a polyurethane composition comprising: (a) a polyfunctional isocyanate; (b) an isocyanate reactive composition; (c) a compound of the formula:

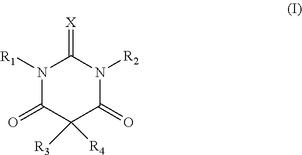

wherein
R₁ and R₂ are individually selected from hydrogen, or an unsubstituted or substituted alkyl, alkenyl, aryl, alkylaryl, or alkoxy group,
R₃ and R₄ are individually selected from hydrogen, or an unsubstituted or substituted alkyl, alkenyl, aryl, alkylaryl, or alkoxy group, subject to the proviso that at least one of R₃ and R₄ is hydrogen,
X is S or O;
   (d) a primary amine containing compound; and (e) a catalyst.

In another embodiment, the present disclosure provides a process for preparation of the polyurethane compositions.

In still another embodiment, the present disclosure provides a method of using the polyurethane compositions to form an interior part of a means of transport.

### DETAILED DESCRIPTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical object of the article. By way of example, “a resin” means one resin or more than one resin.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The present disclosure generally provides a polyurethane composition comprising: (a) a polyfunctional isocyanate; (b) an isocyanate reactive composition; (c) a compound of the formula:

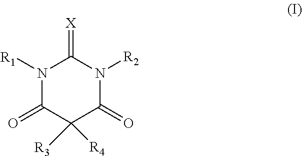

wherein
R₁ and R₂ are individually selected from hydrogen, or an unsubstituted or substituted alkyl, alkenyl, aryl, alkylaryl, or alkoxy group,
R₃ and R₄ are individually selected from hydrogen, or an unsubstituted or substituted alkyl, alkenyl, aryl, alkylaryl, or alkoxy group, subject to the proviso that at least one of R₃ and R₄ is hydrogen,
X is S or O;
   (d) a primary amine containing compound; and (e) a catalyst.

According to one embodiment, the polyfunctional isocyanate includes those represented by the formula Q(NCO)ₙ where n is a number from 2-5, preferably 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms, wherein aromatic hydrocarbon groups are in general preferred.

Examples of polyfunctional isocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (polymeric MDI); norbornane diisocyanates; m- and p-isocyanatophenyl sulfonylisocyanates; perchlorinated aryl polyisocyanates; modified polyfunctional isocyanates containing carbodiimide groups, urethane groups, allophonate groups, isocyanurate groups, urea groups, or biruret groups; polyfunctional isocyanates obtained by telomerization reactions; polyfunctional isocyanates containing ester groups; and polyfunctional isocyanates containing polymeric fatty acid groups. Those skilled in the art will recognize that it is also possible to use mixtures of the polyfunctional isocyanates described above, preferably using mixture of polymeric MDI, mixture of MDI isomers and mixture of TDI.

In another embodiment, prepolymers of MDI or TDI can also be used as an alternative of MDI or TDI. Prepolymers of MDI or TDI are prepared by the reaction of an MDI or TDI and a polyfunctional polyol. The synthesis processes of prepolymers of MDI or TDI are known in the art (see for example Polyurethanes Handbook 2^{nd} edition, G. Oertel, 1994).

The isocyanate reactive composition suitable for use in the present disclosure may include polyfunctional polyol or polyfunctional amine.

The polyfunctional polyols for use in the present disclosure may include, but are not limited to, polyether polyols, polyester polyols, biorenewable polyols, polymer polyols, a non-flammable polyol such as a phosphorus-containing polyol or a halogen-containing polyol. Such polyols may be used alone or in suitable combination as a mixture.

General functionality of polyfunctional polyols used in the present disclosure is from 2 to 6.

The molecular weight of polyols may be in an amount ranging from 200 to 10,000, preferably from 400 to 7,000.

Molecular weight (MW) is weight average molecular weight which is defined by Gel Permeation Chromatography (GPC) method with polystyrene as a reference.

The proportion of said polyfunctional polyols is generally in an amount ranging from 10% to 90% by weight, preferably from 30% to 80% based on the polyurethane composition.

Polyether polyols for use in the present disclosure include alkylene oxide polyether polyols such as ethylene oxide polyether polyols and propylene oxide polyether polyols and copolymers of ethylene and propylene oxide with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols for use in the present disclosure include, but are not limited to, those produced by reacting a dicarboxylic acid with an excess of a diol, for example, adipic acid with ethylene glycol or butanediol, or reaction of a lactone with an excess of a diol such as caprolactone with propylene glycol. In addition, polyester polyols for use in the present disclosure may also include: linear or lightly branched aliphatic (mainly adipates) polyols with terminal hydroxyl group; low molecular weight aromatic polyesters; polycaprolactones; polycarbonate polyol. Those linear or lightly branched aliphatic (mainly adipates) polyols with terminal hydroxyl group are produced by reacting a dicarboxyl acids with an excess of diols, triols and their mixture; those dicarboxyl acids include, but are not limited to, for example, adipic acid, AGS mixed acid; those diols, triols include, but are not limited to, for example, ethylene glycol, diethylene glycol, propylene glycol, dipropylene glycol, 1,4-butane diol, 1,6-hexane diol, glycerol, trimethylolpropane and pentaerythritol. Those low molecular weight aromatic polyesters include products derived from the process residues of dimethyl terephalate (DMT) production, commonly referred to as DMT still bottoms, products derived from the glycolysis of recycled poly(ethyleneterephthalate) (PET) bottles or magnetic tape with subsequent re-esterification with di-acids or reaction with alkylene oxides, and products derived by the directed esterification of phthalic anhydride. Polycaprolactones are produced by the ring opening of caprolactones in the presence of an initiator and catalyst. The initiator includes ethylene glycol, diethylene glycol, propylene glycol, dipropylene glycol, 1,4-butane diol, 1,6-hexane diol, glycerol, trimethylolpropane and pentaerythritol. Polycarbonate polyols are derived from carbonic acid—that can be produced through the polycondensation of diols with phosgene, although transesterification of diols, commonly hexane diol, with a carbonic acid ester, such as diphenylcarbonate.

Biorenewable polyols suitable for use in the present disclosure include castor oil, sunflower oil, palm kernel oil, palm oil, canola oil, rapeseed oil, soybean oil, corn oil, peanut oil, olive oil, algae oil, and mixtures thereof.

Examples of polyfunctional polyols also include, but are not limited to, graft polyols or polyurea modified polyols. Graft polyols comprise a triol in which vinyl monomers are graft copolymerized. Suitable vinyl monomers include, for example, styrene, or acrylonitrile. A polyurea modified polyol, is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol. The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrine or trichlorobutylene oxide.

The polyfunctional amine for use in the present disclosure may include polyether polyamine or polyester polyamine.

In a preferred embodiment, the isocyanate reactive composition is polyether polyol.

It is found that adding compound (c) and (d) in the polyurethane composition of the present disclosure can reduce the aldehyde emission.

Compound (c) is used as aldehyde scavenger of the disclosure. Examples of compound (c) include, but are not limited to, barbituric acid (CAS registry number: 67-52-7) and thio-barbituric acid (CAS registry number: 504-17-6).

The compound (c) is present by weight percentage in the polyurethane composition in an amount ranging from about 0.001 to about 10, preferably from about 0.01 to about 5, and more preferably from about 0.05 to about 2 based on the total weight of the polyurethane composition.

Primary amines arise when one of three hydrogen atoms in ammonia is replaced by an alkyl or aromatic group. The primary amine containing compound suitable for use in the present disclosure may include a compound of the formula:

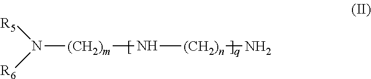

wherein
R₅ and R₆ are individually selected from hydrogen, or an unsubstituted or substituted alkyl, alkenyl, aryl, alkylaryl, or alkoxy group,
m is 2 or 3, n is 2, and q is 0-3.

In embodiments of the present disclosure, the primary amine containing compound may be tetra-ethylene-pentamine (TEPA) or dimethyl-amino-propylamine (DMAPA) and combinations thereof. One skilled in the art, with the benefit of this disclosure will recognize other suitable primary amine containing compounds for use in embodiments of this disclosure, for example, triethylene tetraamine (TETA), pentaethylene hexaamines (PEHA), hexaethylene heptamines (HEHA), heptaethylene octamines (HEOA), octaethylene nonamines (OENO), polyether amine products from Huntsman Corporation such as Jeffamine®D230 amine, Jeffamine®D400 amine, Jeffamine®D2000 amine, Jeffamine®EDR148 amine, Jeffamine®EDR176 amine, Jeffamine®ED600 amine, Jeffamine®ED900 amine, and Jeffamine®ED2003 amine, amines obtained by adducting polyether amine or polyethylene amine with urea or a guanidine compound, such as the amine obtained by reacting guanidine with TETA, and amines obtained from the Michael Addition reaction of a alcohol containing or amino containing tertiary amine followed by hydrogenation, such as the amine obtained by reacting DMAPA with acrylonitrile followed by hydrogenation, and the amine obtained by reacting DMEA (dimethylaminoethanol) with acrylonitrile followed by hydrogenation.

The ratio of compound (c) to compound (d) presented by weight percentage in the polyurethane composition is generally in an amount ranging from about 0.01:1 to about 5:1, preferably from about 0.1:1 to about 3:1, and more preferably from about 0.2:1 to about 2:1.

In the present disclosure, the composition further includes one or more catalysts in order to speed up the reaction between polyfunctional isocyanate and polyfunctional polyol, for example, amine catalyst e.g. N,N-dimethylethanolamine, N,N-dimethyl-N′,N′-di(2-hydroxypropyl)-1,3-propanediamine, 2-((2-(2-(dimethylamino)ethoxy)ethyl)methylamino) ethanol, dimethylcyclohexylamine and triethylene diamine.

In one embodiment, the proportion of the catalysts present in the composition is in an amount ranging from 0.001 to 10 wt %, preferably from 0.1 to 5 wt %.

According to one embodiment, the NCO index of the polyurethane composition is in the range of from 0.8 to about 4, preferably from about 0.8 to about 1.3.

The isocyanate index or NCO index or index is the ratio of NCO-groups over isocyanate-reactive hydrogen atoms present in a formulation.

$$\underline{[ NCO ]} \\ [ active hydrogen ]$$

In other words the NCO-index expresses the amount of isocyanate actually used in a formulation with respect to the amount of isocyanate theoretically required for reacting with the amount of isocyanate-reactive hydrogen used in a formulation.

In another embodiment, the foam composition may further optionally comprises fire retardants, antioxidants, surfactants, physical or chemical blowing agents, chain extender, crosslinking agent, foam stabilizer, fillers, pigments, or any other typical additives used in PU materials.

Advantages of the disclosed composition may include: (1) reduced aldehyde emission, especially formaldehyde and acetaldehyde emission; (2) low cost; and (3) no obvious influence on the mechanic properties of the foam.

The present disclosure also provides a process for making the polyurethane composition, comprising mixing components (b), (c), (d) and (e) to form a mixture, and adding the mixture to component (a). According to one embodiment, the ratio of compound (c) to compound (d) presented by weight percentage in the polyurethane composition is in an amount ranging from about 0.01:1 to about 5:1, preferably from about 0.1:1 to about 3:1, and more preferably from about 0.2:1 to about 2:1.

Furthermore, the present disclosure also provides the method of using the polyurethane composition to form an interior part of a means of transport, preferably an interior cladding of automobiles such as roof cladding, carpet-backing foam, door cladding, steering rings, control knobs and seat cushioning.

Embodiments of the present disclosure can also be applied in other industry areas where the PU foams are used. The PU foam includes flexible PU foam, semirigid PU foam, rigid PU foam, viscoelastic PU foam, integral skin PU foam, hydroponic PU foam and alike.

The examples which now follow should be considered exemplary of the present disclosure, and not delimitive thereof in any way.

Raw Materials

Polyfunctional Isocyanate: mixture of 80 parts by weight of DESMODUR® T 80 TDI (Supplier: Covestro) and 20 parts by weight of SUPRASEC® 5005 polymeric MDI (Supplier: Huntsman Corporation, USA);

Polyol A: a trifunctional copolymer of ethylene and propylene oxide with terminal hydroxyl groups derived from glycerol; has a molecular weight around 6000;

Polyol B: KONIX® KE-880S polymer polyol. Supplier: KPX, Korea;

Foam Stabilizer: TEGOSTAB® B8738 LF2 polymer additive (siloxane based surfactant). Supplier: Evonik;

Catalyst A: JEFFCAT® ZF 10 catalyst (amine catalyst). Supplier: Huntsman Corporation, USA;

Catalyst B: JEFFCAT® DPA catalyst (amine catalyst). Supplier: Huntsman Corporation, USA;

Scavenger A: barbituric acid;

Scavenger B: thio-barbituric acid;

Primary Amine Containing Compound A: tetra-ethylene-pentamine

Primary amine Containing Compound B: dimethy-amino-propylamine

Chain Extender: diethanolamine

### Examples 1-9

Examples 1-9 were produced with the Polyfunctional Isocyanate as the A Component. The B Components for Examples 1 through 9 are shown in Table 1. All values listed in Table 1 refer to parts by weight of the B Component. As shown in Table 1, Examples 4 and 5 were comparative examples that contained no aldehyde scavengers. Examples 6 and 7 were comparative examples that contained no primary amine containing compounds. Example 8 is a comparative example that has too much primary amine containing compound added. Lastly, Example 9 is a comparative example that contained no aldehyde scavenger or primary amine containing compound.

TABLE 1

| | Example | | | | | | | | |
|---|---|---|---|---|---|---|---|---|---|
| B Component Formulation | 1 | 2 | 3 | 4 | 5 | 6 | 7 | 8 | 9 |
| Polyol A | 66 | 66 | 66 | 66 | 66 | 66 | 66 | 66 | 66 |
| Polyol B | 28 | 28 | 28 | 28 | 28 | 28 | 28 | 28 | 28 |
| Foam Stabilizer | 0.66 | 0.66 | 0.66 | 0.66 | 0.66 | 0.66 | 0.66 | 0.66 | 0.66 |
| Catalyst A | 0.14 | 0.14 | 0.14 | 0.14 | 0.14 | 0.14 | 0.14 | 0.14 | 0.14 |
| Catalyst B | 0.9 | 0.9 | 0.9 | 0.9 | 0.9 | 0.9 | 0.9 | 0.9 | 0.9 |
| Scavenger A | 0.2 | | 0.1 | | | 0.1 | 0.2 | 0.1 | |
| Scavenger B | | 0.18 | | | | | | | |
| Primary Amine Containing | 0.1 | 0.1 | | 0.1 | 0.2 | | | 0.2 | |
| Compound A | | | | | | | | | |
| Primary Amine Containing | | | 0.1 | | | | | | |
| Compound B | | | | | | | | | |
| Chain Extender | 0.9 | 0.9 | 0.9 | 0.9 | 0.9 | 0.9 | 0.9 | 0.9 | 0.9 |
| water | 3.1 | 3.12 | 3.2 | 3.3 | 3.2 | 3.3 | 3.2 | 3.1 | 3.4 |

Procedure

For Examples 1-9, the A and B Components were mixed in the proportion (by weight) of A:B=44:100 and at an index of 1.05 and stirred in a polyethylene container to make the polyurea/polyurethane foam. The resulting foam composition was rapidly poured into polyethylene bag. The foaming reaction proceeded and the foam was allowed to free rise. The foams are cured for a minimum of 15 minutes at room temperature before being tested, for each formulation about 1 kilogram (kg) foam was made via hand mix foam procedure for VDA276 emission test. The temperature of the test chamber during the test was 65° C. VDA276 (2005 Edition) is a test method from the Verband der Automobilindustrie (website: https://www.vda.de/de).

Results

Formaldehyde Reduction

TABLE 2

| | Example | | | | | | | | |
|---|---|---|---|---|---|---|---|---|---|
| | 1 | 2 | 3 | 4 | 5 | 6 | 7 | 8 | 9 |
| Reduction of | 77.3 | 76.1 | 57.4 | 14.2 | 18.1 | 0 | 30.4 | 74.38 | 0 |
| formaldehyde | | | | | | | | | |
| emission ¹⁾ | | | | | | | | | |
| [%] | | | | | | | | | |

¹⁾ Tested according to VDA276

Table 2 shows the reduction in formaldehyde emission for Examples 1-9 as tested according to the VDA276 emission test. When both an aldehyde scavenger and a primary amine containing compound are present (Examples 1, 2, 3 and 8), there is a significant reduction in formaldehyde emission. In Examples 4 and 5 (no scavengers) and Examples 6 and 7 (no primary amine containing compound) there is less reduction in formaldehyde emission. Finally, in Example 9 (no aldehyde scavenger or primary amine containing compound), there is no reduction in formaldehyde emission. Comparing Examples 1, 2, 3 and 8 with Examples 4-7, one can see a synergistic effect between the aldehyde scavenger and primary amine containing compound that reduces formaldehyde emission greater than the individual reduction in formaldehyde emission using the aldehyde scavengers alone (Examples 6 and 7) or the primary amine containing compounds alone (Examples 4 and 5).

Acetaldehyde Reduction

TABLE 3

| Example | 1 | 2 | 3 | 8 | 9 |
|---|---|---|---|---|---|
| Reduction of acetaldehyde | 25.47 | 31.6 | 34.2 | −41.8 | 0 |
| emission ¹⁾ [%] | | | | | |

¹⁾ Tested according to VDA276

Table 3 shows the reduction in acetaldehyde emission for Examples 1, 2, 3, 8 and 9 as tested according to the VDA276 emission test. Examples 1-3 of the present disclosure show a reduction of acetaldehyde emission over Example 9 (no aldehyde scavengers or primary amine containing compound). When too much primary amine containing compound is added in the composition (Example 8), there is reduction of the emission of formaldehyde (see Table 2) but the emission of acetaldehyde is increased. However, when the amount of the primary amine containing compound and the amount of the scavenger of the disclosure are adjusted to a proper ratio as in Examples 1-3, there is significant reduction of the emission of both formaldehyde and acetaldehyde as shown in Tables 2 and 3.

1. A polyurethane composition comprising:
(a) a polyfunctional isocyanate;
(b) an isocyanate reactive composition;
(c) a compound of the formula: 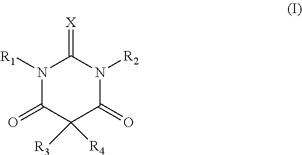
wherein
R₁ and R₂ are individually selected from hydrogen, or an unsubstituted or substituted alkyl, alkenyl, aryl, alkylaryl, or alkoxy group,
R₃ and R₄ are individually selected from hydrogen, or an unsubstituted or substituted alkyl, alkenyl, aryl, alkylaryl, or alkoxy group, subject to the proviso that at least one of R₃ and R₄ is hydrogen,
X is S or O,
(d) a primary amine containing compound; and
(e) a catalyst.

2. The polyurethane composition of claim 1 wherein the polyurethane composition has a NCO index in the range of from about 0.8 to about 4, preferably from about 0.8 to about 1.3.

3. The polyurethane composition of claim 1 wherein the polyfunctional isocyanate is selected from a polymeric methylene diphenyl diisocyanate, a methylene diphenyl diisocyanate isomer mixture, a toluene diisocyanate isomer mixture and a mixture thereof.

4. The polyurethane composition of claim 1, wherein the isocyanate reactive composition is a polyfunctional polyol or a polyfunctional amine, preferably a polyfunctional polyol, and more preferably a polyether polyol.

5. The polyurethane composition of claim 1, wherein the compound (c) is at least one of barbituric acid and thio-barbituric acid.

6. The polyurethane composition of claim 1 wherein the primary amine containing compound is a compound of the formula: 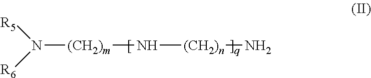
wherein
R₅ and R₆ are individually selected from hydrogen, or an unsubstituted or substituted alkyl, alkenyl, aryl, alkylaryl, or alkoxy group,
m is 2 or 3, n is 2, and q is 0-3.

7. The polyurethane composition of claim 1, wherein the ratio of compound (c) to compound (d) presented by weight percentage in the polyurethane composition is in an amount ranging from about 0.01:1 to about 5:1, preferably from about 0.1:1 to about 3:1, and more preferably from about 0.2:1 to about 2:1.

8. The polyurethane composition of claim 1, wherein the catalyst comprises an amine catalyst.

9. The polyurethane composition of any one of claims 1, wherein the foam composition further comprises at least one chain extender.

10. A process for making the polyurethane composition of any one of claims 1, comprising mixing compounds (b), (c), (d) and (e) to form a mixture, and adding the mixture to compound (a).

11. A method of using the polyurethane composition of any one of the claim 1 to form an interior part of a means of transport.
